(19) United States
(12) Patent Application Publication
(10) Pub. No.: US 2013/0346382 A1
(43) Pub. Date: Dec. 26, 2013

(54) WIDGET PLATFORM EXPOSED FOR DIVERSE ECOSYSTEMS

(71) Applicant: MOHAN RAO VARTHAKAVI, Sammamish, WA (US)

(72) Inventor: MOHAN RAO VARTHAKAVI, Sammamish, WA (US)

(73) Assignee: MICROSOFT CORPORATION, Redmond, WA (US)

(21) Appl. No.: 13/531,009

(22) Filed: Jun. 22, 2012

(51) Int. Cl. G06F 17/30

(52) U.S. Cl. 707/706; 707/E17.108

(57) ABSTRACT

Systems and methods for facilitating exposure of search engine data in intelligent and structured visual controls are provided, permitting developers to access exposed search-engine data that is preprogrammed into the controls. Such controls, for instance, widgets, permit exploitation of search-engine data and visual richness (user experience), and exposure of data and content crawled by a search engine to third party developers in an efficient and flexible fashion. The visual controls are customizable and configured to be incorporated into various computing platforms over diverse ecosystems. The controls may be accessible from an online location available to third party developers for retrieval and embedding of search engine data assets into applications and web sites on various platforms.

### BACKGROUND

There are application and web experiences provided in multiple, diverse computing ecosystems (e.g., mobile, tablet, gaming and personal computing) to enhance productivity and life. These applications expose valuable information/data. Major search providers such as BING and GOOGLE typically have a major subset of this information. This information is typically consumed from experience built by search engines or domain specific applications built by third party developers. The third party developers gather information on their own, causing them to incur the cost of owning and maintaining the data, or by using Application Programming Interfaces (APIs) from the major search providers. There are significant drawbacks with third party developers gathering information via search provider APIs. One drawback is that the third party developers bear the cost of owning and maintaining data. Another drawback is that the third party developers need to develop the user experience around the data. While some developers create specific user experiences for uniqueness, many prefer using user experience characteristics that already exist. Additionally, because the data is being presented in different ways the data and user experience may be inconsistent causing user dissatisfaction.

### SUMMARY

Embodiments of the present invention relate to facilitating exposure of search engine data in intelligent and structured visual controls so that developers on various application platforms are able to use the controls to build applications and web sites more efficiently. Utilizing embodiments of the present invention, developers are able to access exposed search engine data that is preprogrammed into intelligent and structured visual controls, for instance, widgets. Widgets (or other visual user interface controls) permit exploitation of search engine data and visual richness (user experience), and exposure of data and content crawled by a search engine to third party developers in an efficient and flexible fashion. The visual controls are customizable and configured to be incorporated into one or more types of computing platforms over such diverse ecosystems as mobile, tablet, gaming and personal computing. In embodiments, the controls may be accessible from an online location available to third party developers for retrieval and embedding of search engine data assets into applications and web sites on various platforms.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is illustrated by way of example and not limitation in the accompanying figures in which like references numerals indicate similar elements and in which:

FIG. 1 is a block diagram of an exemplary computing system environment suitable for use in implementing embodiments of the present invention;

FIG. 2 is a schematic diagram of an exemplary computing system in which embodiments of the present invention may be employed;

FIG. 3 is schematic diagram of another exemplary computing system in which embodiments of the invention maybe employed;

FIG. 4 is schematic diagram depicting an exemplary technology strategy for exposing visual controls, in accordance with an embodiment of the present invention;

FIGS. 5A and 5B are schematic diagrams of exemplary widgets formatted in the form of grids, in accordance with embodiments of the present invention;

FIGS. 6A and 6B are schematic diagrams of exemplary widgets formatted in the form of lists, in accordance with embodiments of the present invention;

FIGS. 7A and 7B are schematic diagrams of exemplary widgets formatted in the form of answer widgets, in accordance with embodiments of the present invention;

FIGS. 8A, 8B, and 8C are schematic diagrams of exemplary widgets formatted in the form of detail widgets, in accordance with embodiments of the present invention;

FIGS. 9A and 9B are schematic diagrams of exemplary advertisement-formatted widgets, in accordance with embodiments of the present invention;

FIG. 10 is a schematic diagram of an exemplary widget having a user-input region for receiving any of textual, audio or image input, in accordance with an embodiment of the present invention;

FIG. 11 is a schematic diagram of an exemplary input widget configured for receiving visual (e.g., image) input, in accordance with an embodiment of the present invention;

FIG. 12, is a flow diagram illustrating an exemplary method for exposing data associated with a search engine, in accordance with an embodiment of the present invention; and

FIG. 13 is a flow diagram illustrating an exemplary method for incorporating search-engine data into an application, in accordance with an embodiment of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer-readable storage media for facilitating exposure of search engine data in intelligent and structured visual controls so that developers on various application platforms are able to incorporate such information into applications and web-sites more efficiently. As utilized herein, the term “developer” refers to one or more individuals or entities that design, program, and/or modify web pages. A developer may also include any person or entity that has access to a specified online location, as more fully described below, for the purpose of retrieving and incorporating visual user interface controls (e.g., widgets) into an application or website. There may exist additional/other descriptions of a “developer” that may be known by those skilled in the art, not described herein, but applicable.

Utilizing embodiments of the present invention, developers are able to access exposed search engine data that is preprogrammed into intelligent and structured visual controls, for instance, widgets. Widgets (or other visual user interface controls) permit exploitation of search engine data and visual richness (user experience), and exposure of information and content crawled by a search engine to third party developers in an efficient and flexible fashion. The visual controls are customizable and formatted to be incorporated into one or more types of computing platforms over such diverse ecosystems as mobile, tablet, gaming and personal computing. In embodiments, the visual controls may be accessible from an online location available to third party developers for retrieval and embedding of search engine data assets into applications and web sites on various platforms.

Accordingly, one embodiment of the present invention is directed to one or more computer-readable storage media having computer-executable instructions embodied thereon that, when executed, perform a computer-implemented method for exposing data associated with a search engine. The method includes receiving a request for incorporation of search-engine data into at least one of an application and a web site, the search-engine data including one or more of crawled information and content, user-behavior information, and visual information presentation characteristics. The method further includes generating a widget based on at least a first portion of the retrieved search-engine data, the widget being configured to expose at least the first portion of the retrieved search-engine data, and for incorporation into a plurality of application platforms.

In another embodiment, the present invention is directed to a system for exposing data associated with search engines. The system includes a data store storing search-engine data including one or more of crawled information and content, user-behavior information, and visual information presentation characteristics; and a search engine. Access to the search-engine data is powered by the search engine and provided by a widget having a user-input region. Additionally, the widget has one or more customizable characteristics and is configured for incorporation into a plurality of application platforms.

In yet another embodiment, the present invention is directed to a method for incorporating search-engine data into an application. The method includes accessing an online location, the online location providing one or more selectable indicators each configured for incorporating at least a respective portion of the search-engine data into the application via a widget; and selecting at least one of the one or more selectable indicators representing a search-engine data portion desired for incorporation into the application.

Having briefly described an overview of embodiments of the present invention, an exemplary operating environment in which embodiments of the present invention may be implemented is described below in order to provide a general context for various aspects of the present invention.

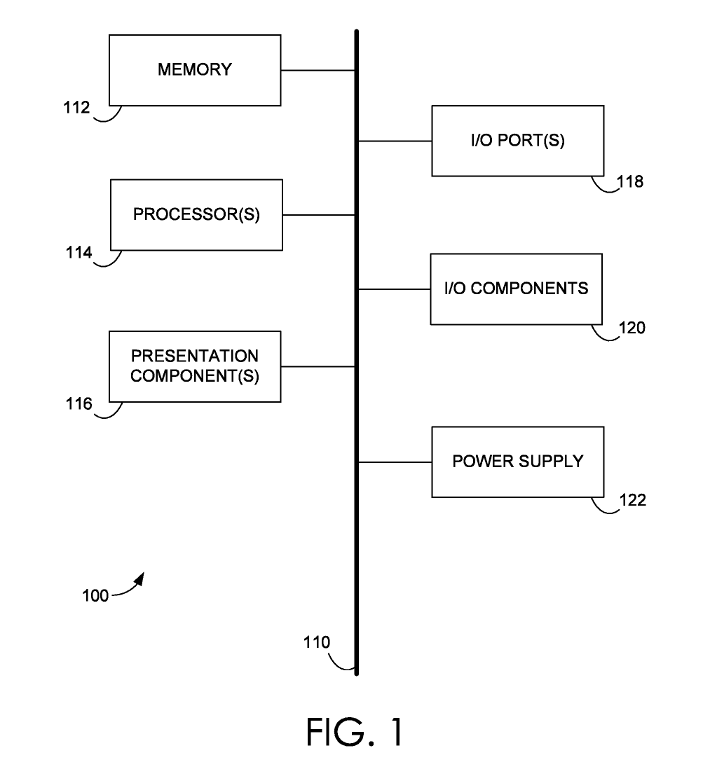

Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network.

In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

With continued reference to FIG. 1, computing device 100 includes a bus 110 that directly or indirectly couples the following elements: memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

The computing device 100 typically includes a variety of computer-readable media. Computer-readable media can be any available media that can be accessed by the computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer storage media in the form of volatile and/or nonvolatile memory. The memory may be removable, non-removable, or a combination thereof. Exemplary hardware devices include solid state memory, hard drives, optical disc drives, and the like. The computing device 100 includes one or more processors that read data from various entities such as the memory 112 or the I/0 components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components 120 include a microphone, joystick, game pad, satellite dish, scanner, printer, wireless device, etc.

As previously mentioned, embodiments of the present invention are generally directed to systems, methods and computer-readable storage media for, among other things, facilitating exposure of search engine data in intelligent and structured visual controls so that developers on various application platforms are able to incorporate such information into applications and web sites more efficiently. Utilizing embodiments of the present invention, developers are able to access exposed search engine data that is preprogrammed into intelligent and structured visual controls, for instance, widgets. Widgets (or other visual user interface controls) permit exploitation of search engine data and visual richness, and exposure of information and content crawled by a search engine to third party developers in an efficient and flexible fashion. The visual controls are customizable and formatted to be incorporated into one or more types of computing platforms over such diverse ecosystems as mobile, tablet, gaming and personal computing. In embodiments, the visual controls may be accessible from an online location available to third party developers for retrieval and embedding of search engine data assets into applications and web sites on various platforms.

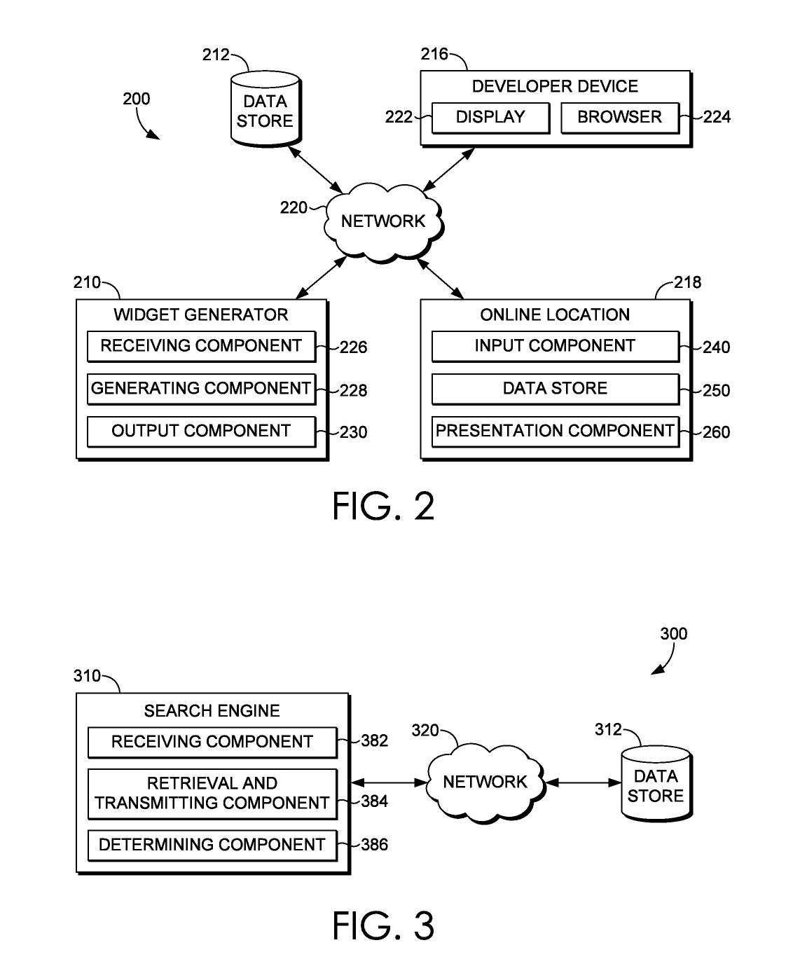

Referring now to FIG. 2, a block diagram is provided illustrating an exemplary computing system 200 in which embodiments of the present invention may be employed. Generally, the computing system 200 illustrates an environment in which search engine information may be exposed in intelligent and structured controls so that developers on various application platforms are able to incorporate such information into applications and web sites more efficiently, as will be described in further detail below.

Among other components not shown, the computing system 200 generally includes a widget generator 210, a data store 212, a developer device 216, and an online location 218, all in communication with one another via a network 220. The network 220 may include, without limitation, one or more local area networks (LANs) and/or wide area networks (WANs). Such networking environments are commonplace in offices, enterprise-wide computer networks, intranets and the Internet. Accordingly, the network 220 is not further described herein.

It should be understood that any number of widget generators, data stores, developer devices, and online locations may be employed in the computing system 200 within the scope of embodiments of the present invention. Each may comprise a single device/interface or multiple devices/interfaces cooperating in a distributed environment. For instance, the widget generator 210 may comprise multiple devices and/or modules arranged in a distributed environment that collectively provide the functionality of the widget generator 210 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the developer device 216, as an Internet-based service, or as a module inside the widget generator 210. It will be understood by those of ordinary skill in the art that the components/modules illustrated in FIG. 2 are exemplary in nature and in number and should not be construed as limiting Any number of components/modules may be employed to achieve the desired functionality within the scope of embodiments hereof. Further, components/modules may be located on any number of widget generators, developer computing devices, and/or devices associated with online locations.

It should be understood that this and other arrangements described herein are set forth only as examples. Other arrangements and elements (e.g., machines, interfaces, functions, orders, and groupings of functions, etc.) can be used in additional to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The data store 212 is configured to store data associated with a search engine. Such data may include, without limitation, crawled information and content, user-behavior information (e.g., information regarding how users respond to particular content), and visual information presentation characteristics (e.g., information regarding the user experience provided by exposure of search-engine data in different ways). In embodiments, the data store 212 is configured to be searchable for one or more of the items stored in association therewith. It will be understood and appreciated by those of ordinary skill in the art that the information stored in association with the data store 212 may be configurable and may include any data collected and/or maintained by a search engine. The content and volume of such information are not intended to limit the scope of embodiments of the present invention in any way. Further, though illustrated as a single, independent component, the data store 212 may, in fact, be a plurality of storage devices, for instance a database cluster, portions of which may reside in association with the widget generator 210, the developer device 216, a device associated with the online location 218, another external computer device (not shown), and/or any other combination thereof.

The developer device 216 may include any type of computing device, such as the computing device 100 described with reference to FIG.1, for example. Generally, the developer device 216 includes a browser 224 and a display 222. The browser 224 is configured to receive user input of requests for various web pages (including pages related to the online location 218), receive user input (generally via a user interface presented on the display 222 and permitting alphanumeric and/or textual input into a designated input region) and to receive content for presentation on the display 222, for instance, from the online location 218. Exemplary content that may be received for presentation on the display 222 includes one or more selectable indicators configured for incorporating information associated with a search engine into an application via a widget, as more fully described below. It should be noted that the functionality described herein as being performed by the browser 224 may be performed by any other application capable of rendering Web content. Any and all such variations, and any combination thereof, are contemplated to be within the scope of the embodiment of the present invention.

The widget generator 210 is configured to generate widgets based on search-engine data retrieved, for instance, from the data store 212. Generated widgets are configured to expose at least a portion of retrieved search-engine data and to be incorporated into a plurality of application platforms, as more fully described below. As illustrated, the widget generator 210 includes a receiving component 226, a generating component 228, and an output component 230.

The receiving component 226 of the widget generator 210 is configured to receive a request for incorporation of search-engine data (e.g., search-engine data stored in association with the data store 212) into at least one of an application and a web site. Typically, such requests are received from the online location 218 (via the network 220) upon input of the request by an application developer. It will be understood and appreciated by those of ordinary skill in the art, however, that such requests may be received directly and without involvement of the online location 218. Any and all such variations, and any combination thereof, are contemplated to be within the scope of embodiments of the present invention.

The generating component 228 of the widget generator 210 is configured to generate a widget based on search-engine data, for instance, data stored in association with the data store 212. In embodiments, the widget generator generates one or more types of widgets including, but not limited to, data widgets and input widgets. In other embodiments, the widget generator generates widgets that include one or more customizable characteristics. Further, in embodiments, generated widgets are configured to be incorporated in a plurality of computing platforms. Exemplary characteristics of such embodiments are more fully described below.

The output component 230 of the widget generator 210 is configured to output generated widgets for incorporation into applications and web sites. In one embodiment, the output component 230 outputs generated widgets to the online location 218 where each may be represented by a selectable indicator that indicates at least a portion of the search-engine data that will be incorporated into a given application or web site upon incorporation thereof into an application or web site. Such embodiment is more fully described below.

As illustrated in FIG. 2, the online location 218 includes an input component 240, a data store 250 and a presentation component 260. In one embodiment, the input component 240 is configured to receive widgets, for instance, from the widget generator 210. In other embodiments, the input component 240 is configured to retrieve widgets, for instance from the widget generator 210, the data store 212, or any other device (not shown). Any and all such variations, and any combination thereof, are contemplated to be within the scope of embodiments of the present invention.

The data store 250 of the online location 218 is configured to store the widgets received by the input component 240. It will be understood and appreciated by those of ordinary skill in the art, however, that widgets received by the input component 240 may also be stored in association with the data store 212 and accessed via the network 220. Additionally, widgets received by the input component 240 may be stored in association with another data store (not shown). Any and all such variations, and any combination thereof, are contemplated to be within the scope of embodiments of the present invention.

The presentation component 260 of the online location 218 is configured to present widgets upon request. The presentation component 260 is further configured to allow a developer device, e.g., the developer device 216, to retrieve a widget for incorporation into an application or web site (for instance, by embedding). As discussed in detail below, widgets generated in accordance with embodiments hereof are configured to be incorporated into a plurality of computing platform types.

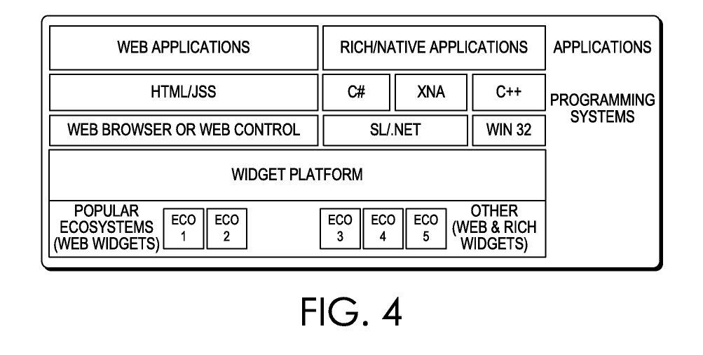

As previously set forth, widgets generated in accordance with embodiments hereof are configured to be incorporated into a plurality of computing platforms. A computing platform includes hardware architecture and software framework, where the combination allows software, particularly application software, to run. The computing platforms applicable to the present invention include, but are not limited to, HTML/JSS, XNA, C++, WIN 32, and SL/.NET. Providing a widget that is configured to be incorporated into a plurality of computing platforms allows search engine data to be uniformly distributed to developers. For instance, if a developer is writing an application on iPhone® and needs a control that displays the weather given a specific location, the developer may be able to retrieve a weather widget compatible with the iOS® platform. The weather widget in the iOS® platform will provide the same information as a weather widget in an Android platform. By providing search-engine data stored in association with the data store 212 via a variety of computing platforms, a developer does not have to lose out on the quality of data provided by the widget due to platform restrictions and is able to provide a consistent user experience. A schematic diagram showing an exemplary technology strategy for exposing visual controls, and including exemplary computing platforms that may be utilized in accordance with embodiments of the present invention, is shown with reference to FIG. 4.

In embodiments, widgets generated in accordance with embodiments hereof include characteristics that may be customized, for instance, by a developer incorporating the widget into an application and/or web site. In embodiments, such customizable characteristic may include, without limitation, visual items such as the background, font size, font type, and visibility of the widget.

In accordance with embodiments hereof, generated widgets may be categorized as those based on data (data widgets) and those based on input (input widgets). It will be understood by those of ordinary skill in the art that the categorization described herein is but one suitable example of a categorization scheme that may be utilized and utilization of other categorization schemes is contemplated to be within the scope of embodiments hereof.

Data widgets provide the ability to visually present any type of search-engine data based on a query and using a particular look and feel associated with a given search engine. The input into a data widget may be received directly via the widget or may be a follow-up action from an input widget (more fully described below). Examples of search-engine data that may be exposed through data widgets include, without limitation, image galleries or grids, weather, directions, local search results, deals and map canvases. Generally, data widgets are generated based on information associated with a particular search engine. Data widgets continue to be based on search-engine data associated with a particular search engine, even if the search engine is associated with one platform and the widget is incorporated into a different platform. For example, a data widget may be based on search engine data provided by Microsoft Corporation of Redmond Wash. but be incorporated into an APPLE platform.

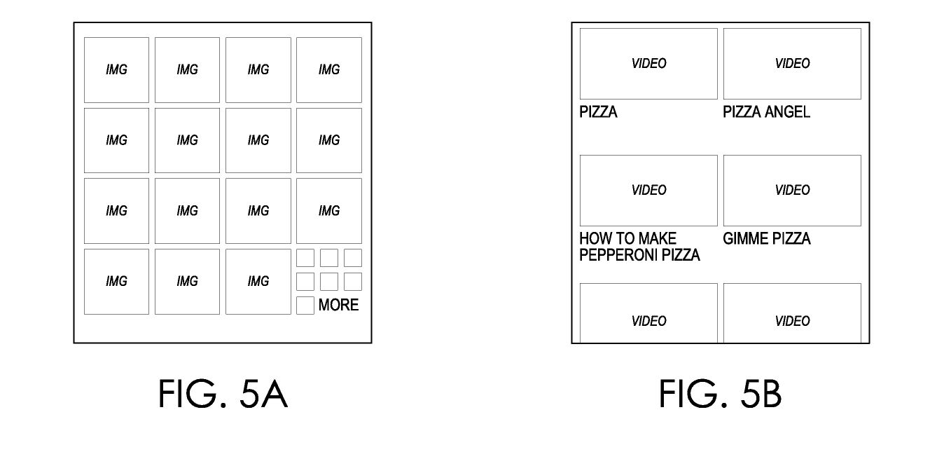

Exemplary data widgets that may be generated in accordance with embodiments hereof may be formatted into the form of a grid. A grid-formatted widget presents data in a grid-type gallery and actions are triggered based upon selection of a presented item. Exemplary grid-type galleries include image galleries and video galleries. Exemplary embodiments of grid widgets are shown with reference to the schematic diagrams of FIGS. 5A and 5B. One or more characteristics of a grid widget may be customized by a developer including, but not limited to: query text, number of rows, number of columns, size of row, size of column, background, font, size and visibility of the widget.

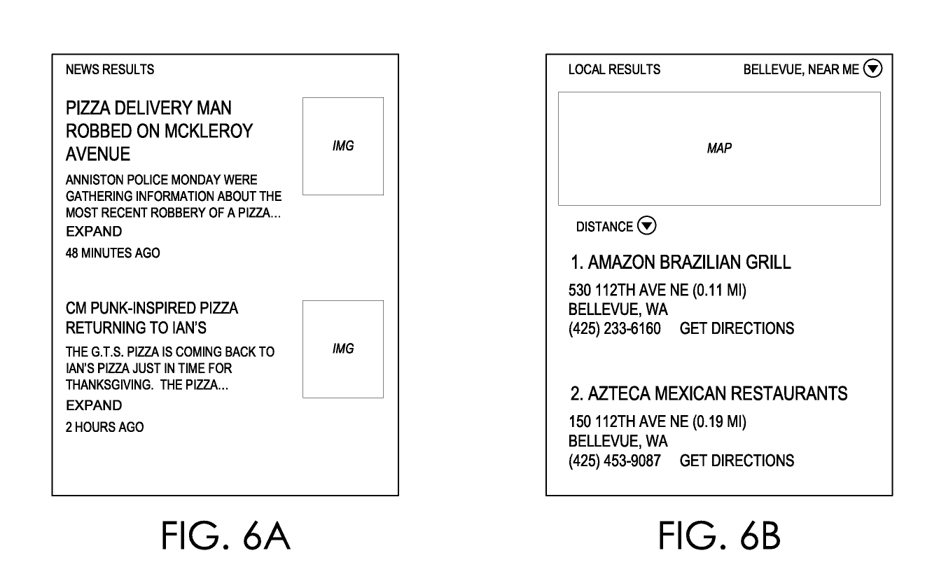

Additional exemplary data widgets that may be generated in accordance with embodiments hereof may be formatted into the form of a list. A list-formatted widget presents data in a list control and actions are triggered based upon selection of a presented item. Exemplary list-type widgets include a news lists or business listings. Exemplary embodiments of list widgets are shown in the schematic diagrams of FIGS. 6A and 6B. One or more characteristics of a list widget may be customized by a developer, including, but not limited to: query text, number of items on the list, background, font, size and visibility of the widget.

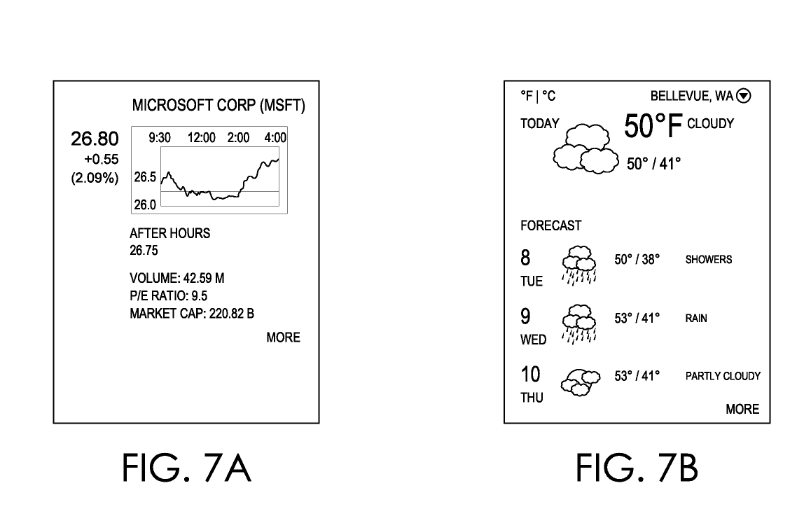

Other exemplary data widgets that may be generated in accordance with embodiments hereof may be formatted into the form of an answer. An answer-formatted widget presents an answer. For example, an answer-formatted widget may show the weather as part of an answer. Exemplary embodiments of answer-formatted widgets are shown in the schematic diagrams of FIGS. 7A and 7B. One or more characteristics of an answer widget may be customized by a developer including, but not limited to: query text, background, font, size and visibility of the widget.

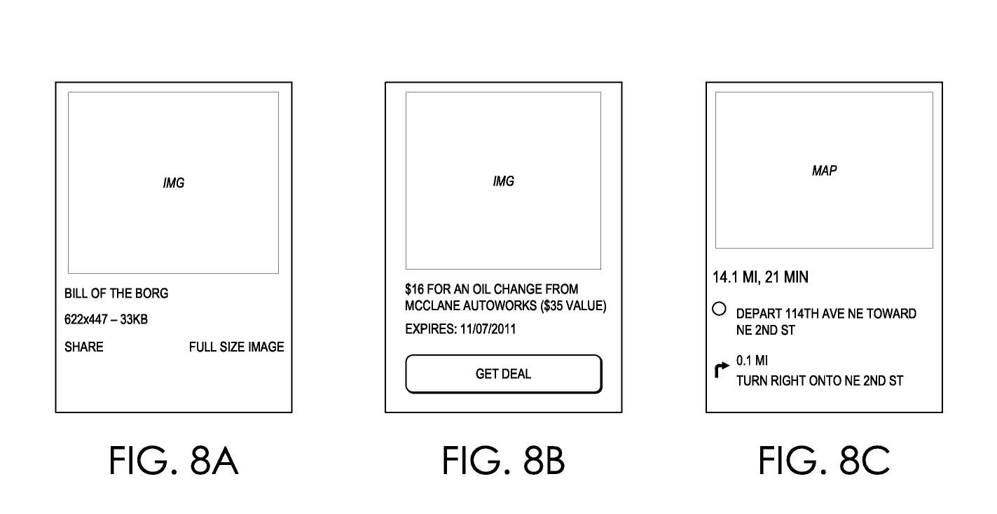

Additional exemplary data widgets may be formatted to address particular details. A detail-formatted widget presents a specific item of data associated with a particular domain and includes interactions specific to the type of domain data. One exemplary detail-formatted widget is a map with location details or direction details. Exemplary embodiments of detail-formatted widgets are shown in the schematic diagrams of FIGS. 8A, 8B, and 8C. One or more characteristics of detail-widgets may be customized by a developer including, but not limited to: query text, background, font, size and visibility of the widget.

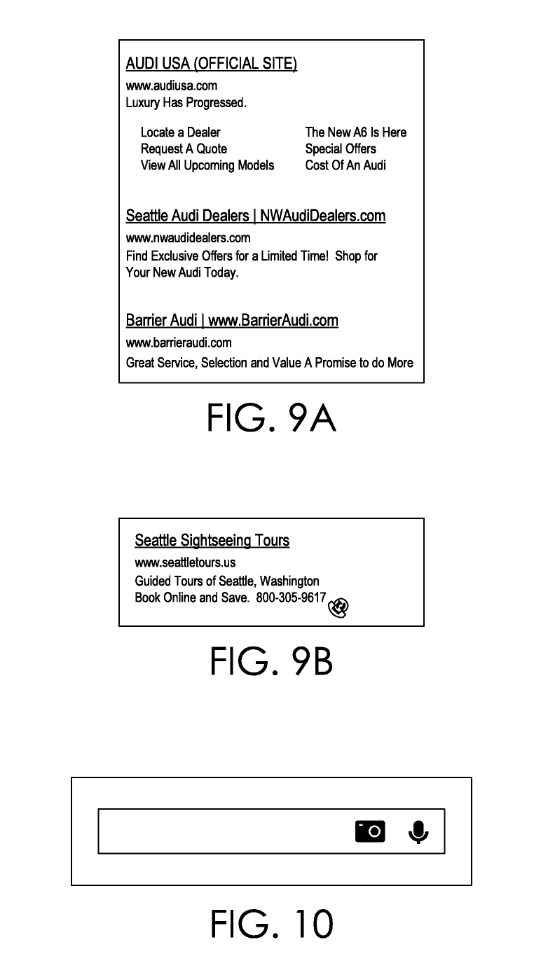

Other exemplary data widgets may be formatted to present contextual and/or display advertisements. Appropriate interactions with advertisement-widgets navigate the user to associated provider sites as well as instrument the impression. The impression will be tracked based on the widget being visible so that the display of the ad widget is recorded in the system for tracking/auditing purposes. Exemplary embodiments of advertisement-formatted widgets are shown in the schematic diagrams of FIGS. 9A and 9B. One or more characteristics of advertisement-widgets may be customized by a developer including, but not limited to: query text, background, font, size and visibility of the widget.

As previously set forth, in addition to data widgets, widgets generated in accordance with embodiments hereof may be based on input (input widgets). An input widget provides a way of receiving user input through natural input methods and actions are triggered after processing of the input received. There are several natural input methods including, but not limited to, text, speech and image. An exemplary widget having a user-input region for receiving any of textual, audio or image (e.g., camera images, scanner images, etc.) input is shown in the schematic diagram of FIG. 10.

In one embodiment, an input widget may receive input into a user-input region in the form of text. A textual input control in accordance with embodiments hereof is configured to receive textual input and may also power the textual input with search engine query suggestions (e.g., alternate input suggestions and/or additional input term suggestions). In another embodiment, an input widget may receive input into a user-input region in the form of audio (e.g., speech) input.

A speech input control in accordance with embodiments hereof is configured to listen to the user and may power the speech recognition using search-engine data. The speech input typically integrated into operating systems does mostly recognition but the results are not typically augmented with information, e.g., regarding an entity type. For instance, if the input speech is “123 Maple Avenue, Seattle, Wash.,” the typical platform-specific voice input only provides to a point where the speech is recognized as text. In embodiments, a speech input control in accordance with the present invention may augment the results with search-engine data, e.g., entity-specific data such as latitude and longitude, company name and the like.

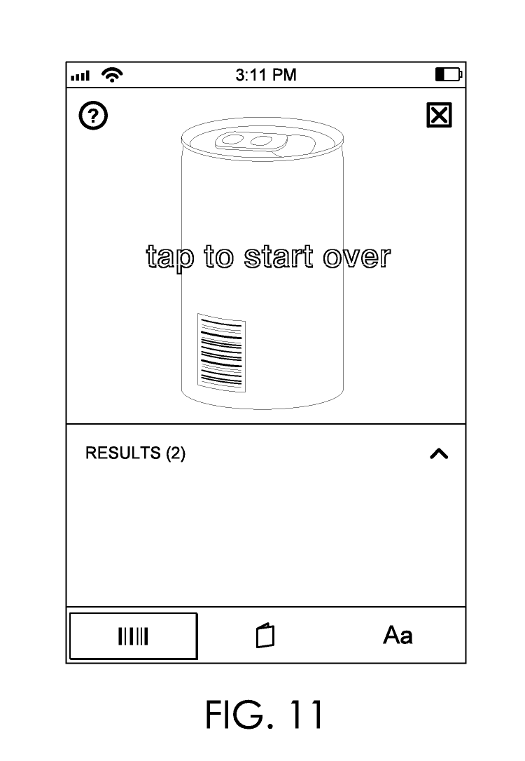

In yet another embodiment, an input widget may receive input into a user-input region in the form of visual input, for instance, as an image. An exemplary input widget that has received image input is shown in the schematic diagram of FIG. 11. An image input control in accordance with embodiments hereof may be configured to scan a user-specified object and power object-recognition using search-engine data. Thus, the results may be augmented with search-engine data, e.g., entity-specific data such as latitude and longitude, company name and the like. The ability to scan a user-specified object is of great value both to the users and also for the search engine. In embodiments, Optical Character Recognition (OCR) may be provided and will add significant value by augmenting the same with images, bar codes, and the like.

Input controls in accordance with embodiments hereof are configured to perform specific actions based upon an input query. One such action is calling a particular Uniform Resource Locator (URL). In embodiments, the default URL is a URL associated with the search engine provider associated with the search-engine data. Such URLs may be augmented, however, by providing additional URLs such as site specific search or custom URLs that provide query results to the user. Generally, custom URLs are configured to provide results in a pre-defined schema.

One exemplary input widget that may have a portion or all of the above-described features, is a search engine widget powered by a search engine and configured to provide access to search-engine data upon receipt of user input into a user-input region. A schematic diagram of an exemplary computing system 300 in which such an embodiment of the present invention may be employed is shown in FIG. 3. The computing system 300 includes a search engine 310 and a data store 312 in communication with one another via a network 320. The data store 312 and the network 320 function is the same or similar manner as the network 220 and data store 212 described above with reference to FIG. 2. Accordingly, the data store 312 and the network 320 are not further described herein.

The search engine 310 includes a receiving component 382, a retrieval and transmitting component 384, and a determining component. The receiving component 382 is configured to receive a search query in one or more input formats, for instance, text, speech and/or audio input as described above. The determining component 386 is configured to determine satisfying search results. In embodiments, such determination is powered by the search engine. The retrieval and transmitting component 384 is configured to query search-engine data (stored in association with the data store 312 through the network 320) and retrieve search results that satisfy the received query. The retrieval and transmitting component 384 is further configured to transmit the satisfying results for presentation in association with, for instance, a display device associated with the querying user.

In embodiments, a search engine widget in accordance with embodiments of the present invention is configured to be incorporated in one or more computing platforms, including, but not limited to HTML/JSS, XNA, C++, WIN 32, and SL/.NET.

Further, in embodiments, user information is received through the search engine widget and results are tailored based upon the received user information. In such embodiments, the search engine widget may receive the input and user information. The user information may include geographic location indicators, e.g., the latitude or longitude of the user. Such embodiments may include comparing the results to the user information and then tailoring the results based on the comparison.

In embodiments, the search engine widget may provide input suggestions based on user-behavior information. In such embodiments, the input may be compared to user-behavior information stored in a data store, for instance, the data store 312 of FIG. 3. Based on the comparison, suggested inputs may be provided. The suggestions will be displayed in the form of text or audio.

Additionally, in embodiment, the search engine widget may permit retrieval of data from the same data store regardless of the computing platform into which the search engine widget is incorporated. For instance, the search engine widget may be incorporated into an ANDROID platform but may retrieve data from a non-ANDROID data store. In other embodiments, the search engine may be customized to call on a specific custom uniform resource locator.

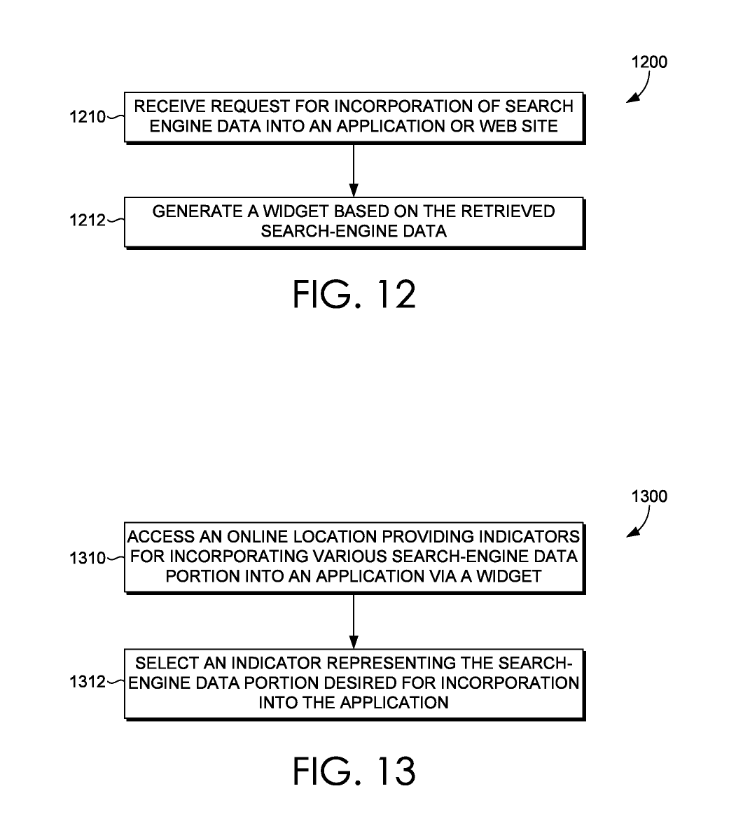

With reference now to FIG. 12, a flow diagram is shown illustrating an exemplary method 1200 for exposing data associated with a search engine. As shown at block 1210, a request for incorporation of search-engine data into at least one of an application and a web site is received. The search-engine data may include one or more of crawled information and content, user-behavior information, and visual information presentation characteristics. As shown at block 1212, a widget (or other visual input control) is then generated based upon at last a first portion of the retrieved search engine data. The widget is configured to expose at least the first portion of the retrieved search-engine data and configured for incorporation into a plurality of application platforms.

With reference to FIG. 13, a flow diagram is shown illustrating an exemplary method 1300 for incorporating search-engine data into an application. As shown at block 1310, an online location is accessed (for instance, by an application developer), the online location providing one or more selectable indicators each configured for incorporating at least a respective portion of the search-engine data into the application via a widget (or other visual input control). As shown at block 1312, at least one of the one or more selectable indicators is selected (for instance, by the application developer), the selected indicator representing a search-engine data portion desired for incorporation into the application.

Embodiments of the present invention provide several benefits to both developers and search engine providers. The benefits for developers include, but are not limited to, a reduced development time for common sets of scenarios, reductions of data acquisition and maintenance costs, consistent data across computing platforms, customizable widgets and an online location to gather the widgets. The benefits of the present invention to search engine providers include, but are not limited to, increased engagement and query volume, an additional opportunity to provide advertisement inventory to third party developers, an opportunity to receive more feedback from users.

As can be understood, embodiments of the present invention provide systems and methods for exposing search-engine data in intelligent and structured visual controls. The present invention has been described in relation to particular embodiments, which are intended to in all respects be illustrative rather than restrictive. Alternative embodiments will become apparent to those of ordinary skill in the art to which the present invention pertains without departing from its scope. While the invention is susceptible to various modifications and alternative constructions, certain illustrated embodiments thereof are shown in the drawings and have been described in detail. It should be understood, however, that there is no intention to limit the invention to the specific forms disclosed, but on the contrary, the intention is to cover all modifications, alternative constructions, and equivalents failing within the spirit and scope of the invention.

It will be understood by those of ordinary skill in the art that the order of steps described in the present invention are not meant to limit the scope of the present invention in any way and, in fact, the steps may occur in a variety of different sequences within embodiments hereof. Any and all such variations, and any combination thereof, are contemplated to be within the scope of embodiments of the present invention.

1. One or more computer-readable storage media having computer-executable instructions embodied thereon that, when executed, perform a computer-implemented method to expose data associated with a search engine, the method comprising:
receiving a request for incorporation of search-engine data into at least one of an application and a web site, the search-engine data including one or more of crawled information and content, user-behavior information, and visual information presentation characteristics; and
generating a widget based on at least a first portion of the retrieved search-engine data, the widget being configured to expose at least the first portion of the retrieved search-engine data, and for incorporation into a plurality of application platforms.

2. The computer-readable storage media of claim 1, wherein the method further comprises embedding the widget into the at least one of the application and the web site.

3. The computer-readable storage media of claim 1, wherein the method further comprises providing an online location where the request for incorporation of the search engine data into the at least one of the application and the web site may be submitted.

4. The computer-readable storage media of claim 1, wherein one or more characteristics of the widget are customizable, and wherein the one or more customizable characteristics include at least one of query text, background, font, size, and visibility of the widget.

5. The computer-readable storage media claim 1, wherein the widget is formatted to present at least a second portion of the retrieved search-engine data in the form of a grid, and wherein one or more visual characteristics of the grid are customizable, the customizable grid characteristics including at least one of query text, row number, column number, row size, column size, background, font, and grid size.

6. The computer-readable storage media claim 1, wherein the widget is formatted to present at least a second portion of the retrieved search-engine data in the form of a list, and wherein one or more visual characteristics of the list are customizable, the customizable list characteristics including at least one of query text, number of list items, background, font, and list size.

7. The computer-readable storage media claim 1, wherein the widget is formatted to present at least a second portion of the retrieved search-engine data in the form of an answer, and wherein one or more visual characteristics of the answer are customizable, the customizable answer characteristics including at least one of query text, background, font, and size.

8. The computer-readable storage media of claim 1, wherein the widget is formatted to provide details of at least one domain specific item.

9. The computer-readable storage media of claim 1, wherein the widget is formatted to display an advertisement, and wherein upon receiving a user selection of the widget, the method further comprises navigating the user to a web site associated with the advertisement.

10. A system for exposing data associated with search engines, the system comprising:
a data store storing search-engine data including one or more of crawled information and content, user-behavior information, and visual information presentation characteristics; and
a search engine, wherein access to the search-engine data is powered by the search engine and provided by a widget having a user-input region, the widget having one or more customizable characteristics and being configured for incorporation into a plurality of application platforms.

11. The system of claim 10, wherein the search engine receives a query from a user via the user-input region of the widget, and performs an action based on the query.

12. The system of claim 11, wherein the search engine performs the action by:
gathering user information including an indicator of a geographic location of the user;
comparing the user information to the search-engine data; and
tailoring the action based on the comparison.

13. The system of claim 11, wherein the query is a search query in the format of text, and wherein the search engine performs the action by:
comparing the query to the search-engine data;
providing at least one of a suggested alternate query or suggested additional query term to the user;
querying a Uniform Resource Locator (URL) for query results, wherein the URL is customizable by an application developer; and
providing at least a portion of the query results to the user.

14. The system of claim 11, wherein the query is a search query in the format of audio input, and wherein the search engine performs the action by:
comparing the audio input to the search-engine data;
providing at least one of a suggested alternate audio query or suggested additional audio query term to the user;
querying a Uniform Resource Locator (URL) for query results, wherein the URL is customizable by an application developer; and
providing at least a portion of the query results to the user.

15. The system of claim 11, wherein the query is a search query in the format of an image, and wherein the search engine performs the action by:
querying a Uniform Resource Locator (URL) for query results, wherein the URL is customizable by an application developer; and
providing at least a portion of the query results to the user.

16. A method for incorporating search-engine data into an application, the method comprising:
accessing an online location, the online location providing one or more selectable indicators each configured for incorporating at least a respective portion of the search-engine data into the application via a widget; and
selecting at least one of the one or more selectable indicators representing a search-engine data portion desired for incorporation into the application.

17. The method of claim 16, wherein one or more characteristics of the widget are customizable, and wherein the one or more customizable characteristics include at least one of query text, background, font, size, and visibility of the widget.

18. The method of claim 16, wherein the widget is formatted to present a respective portion of the search-engine data associated therewith in the form of a grid, and wherein one or more visual characteristics of the grid are customizable, the customizable grid characteristics including at least one of query text, row number, column number, row size, column size, background, font, and grid size.

19. The method of claim 16, wherein the widget is formatted to present a respective portion of the search-engine data associated therewith in the form of a list, and wherein one or more visual characteristics of the list are customizable, the customizable list characteristics including at least one of query text, number of list items, background, font, and list size.

20. The method of claim 16, wherein the widget is formatted to present a respective portion of the search-engine data associated therewith in the form of an answer, and wherein one or more visual characteristics of the answer are customizable, the customizable answer characteristics including at least one of query text, background, font, and size.
